(19) United States
(12) Patent Application Publication
(10) Pub. No.: US 2008/0314363 A1
(43) Pub. Date: Dec. 25, 2008

(54) Actuated cool combustion emissions solution for auto-igniting internal combustion engine

(75) Inventor: Brett Bailey, Peoria, IL (US)

Correspondence Address: CATERPILLAR c/o LIELL, MCNEIL & HARPER, P.O. BOX 2417, 511 SOUTH MADISON STREET, BLOOMINGTON, IN, 47402-2417, US

(73) Assignee: Caterpillar Inc.

(21) Appl. No.: 11/820,381

(22) Filed: Jun. 19, 2007

(51) Int. Cl. F02F 3/28

(52) U.S. Cl. 123/445; 123/193.4

(57) ABSTRACT

Lower temperature combustion, which may lead to lower emissions, is accomplished by displacing air adjacent to a fuel injector nozzle. Initially, air is compressed in an engine cylinder by moving the engine piston toward top dead center. Air is displaced through a flow passage within the engine cylinder when the engine piston is in the vicinity of top dead center by moving an air displacement actuator. The air displacement actuator includes a member positioned in the combustion chamber that moves with respect to the engine housing and the piston when actuated. This movement causes air to flow through a flow passage, and fuel is injected into the turbulent compressed air flowing through the flow passage. The mixture of air and fuel are compression ignited in the engine cylinder after a brief ignition delay. Lower emissions may be achieved by bringing the air to the fuel prior to ignition, rather than attempting to bring the fuel to the air as in a typical compression ignition engine.

### TECHNICAL FIELD

The present disclosure relates generally to low emissions cool combustion in an internal combustion engine, and relates more particularly to an air displacement actuator to facilitate bringing air to the fuel for better mixing prior to ignition in a combustion chamber of an engine.

### BACKGROUND

Traditional compression engines operate by injecting fuel into relatively stagnant compressed air in the vicinity of top dead center. The air is compressed to pressures and temperatures that cause directly injected liquid fuel to auto-ignite upon injection after an ignition delay. Current compression ignition engines create undesirable emissions that include nitrous oxide (NOx), unburned hydrocarbons and particulate matter as a byproduct of combustion. NOx is generally a result of the fuel being combusted at or near stoichiometric conditions with temperatures above the NOx production threshold temperature. Particulate matter is generally believed to be the result of a fuel rich combustion plume arising from the injection of fuel into a relatively stagnant volume of compressed air. Unburned hydrocarbons are generally believed to be the result of inadequate air being available in the vicinity of the fuel during combustion while temperature and pressure remain above an auto-ignition point.

One relatively new method of auto-igniting fuel in an internal combustion engine to achieve lower emissions is often referred to as homogeneous charge compression ignition (HCCI). This method includes mixing fuel with air before compressing the mixture to an auto-ignition point. HCCI has proven the ability to produce extremely low NOx emissions. However, HCCI is not without problems. For instance, controlling ignition timing, achieving high load operation and producing excess particulate matter have all been challenges facing developers of HCCI engines.

Another approach for reducing emissions has been a reliance upon ever more sophisticated after-treatment processes. Although after-treatment can effectively remove substantial amounts of undesirable emissions from internal combustion engine exhaust, they merely treat the symptoms of an emissions problem rather than addressing the problem of how to avoid creating undesirable emissions at the time of combustion.

The present disclosure is directed to these and other problems associated with undesirable emissions from compression ignition engines.

### SUMMARY OF THE DISCLOSURE

A method of operating an internal combustion engine includes compressing air in an engine cylinder by moving an engine piston toward a top dead center position. Air is displaced through a flow passage within the engine cylinder when the engine piston is in a vicinity of top dead center by moving an air displacement actuator with respect to the cylinder and piston. Fuel is injected into air flowing through the flow passage. The mixture of air and fuel is compression ignited in the engine cylinder.

In another aspect, an engine includes a housing defining at least one combustion chamber. A piston is positioned to reciprocate in each of the at least one combustion chamber. An air displacement actuator includes a member positioned in the combustion chamber. The member moves with respect to the housing and the piston when the air displacement actuator is actuated. A fuel injector with a nozzle is positioned in the combustion chamber.

In still another embodiment, an air displacement actuator includes a fuel injector with an injector body that includes an actuation surface and a member that defines a flow passage therethrough. At least one nozzle opening opens into the flow passage.

### BRIEF DESCRIPTION OF THE DRAWINGS

FIGS. 1-8 are a sequence showing relative positions of engine components at different points during one engine cycle according to one aspect of the present disclosure;

FIG. 9 is a schematic illustration of an engine according to one embodiment of the present disclosure;

FIG. 10 is a schematic of an engine according to another embodiment of the present disclosure; and

FIG. 11 is a graph of equivalence ratio φ versus combustion temperature T, that identifies particulate matter production and NOx production regimes.

### DETAILED DESCRIPTION

The present disclosure describes an engine and its method of operation that provides a strategy for bringing air to the fuel, rather than vice versa as in conventional diesel engine operation. In addition, the strategy of the present disclosure provides for more thorough mixing of fuel and air to achieve low emissions cool combustion similar to that achieved in homogeneous charge compression ignition engines, but without the ignition timing problems associated with HCCI engines. In addition, the present disclosure seeks to maintain the elevated performance levels associated with conventional diesel engines by promoting combustion at a location in the engine cylinder that reduces heat rejection losses through the engine head and cylinder walls. These and other related goals are accomplished by including an air displacement actuator that moves the air within the engine cylinder when the air would otherwise be relatively stagnant when the piston is in the vicinity of top dead center. The air displacement actuator can take a number of forms, but may include a member that moves in the engine cylinder with respect to the piston and the cylinder to facilitate air movement adjacent a fuel injector nozzle during injection.

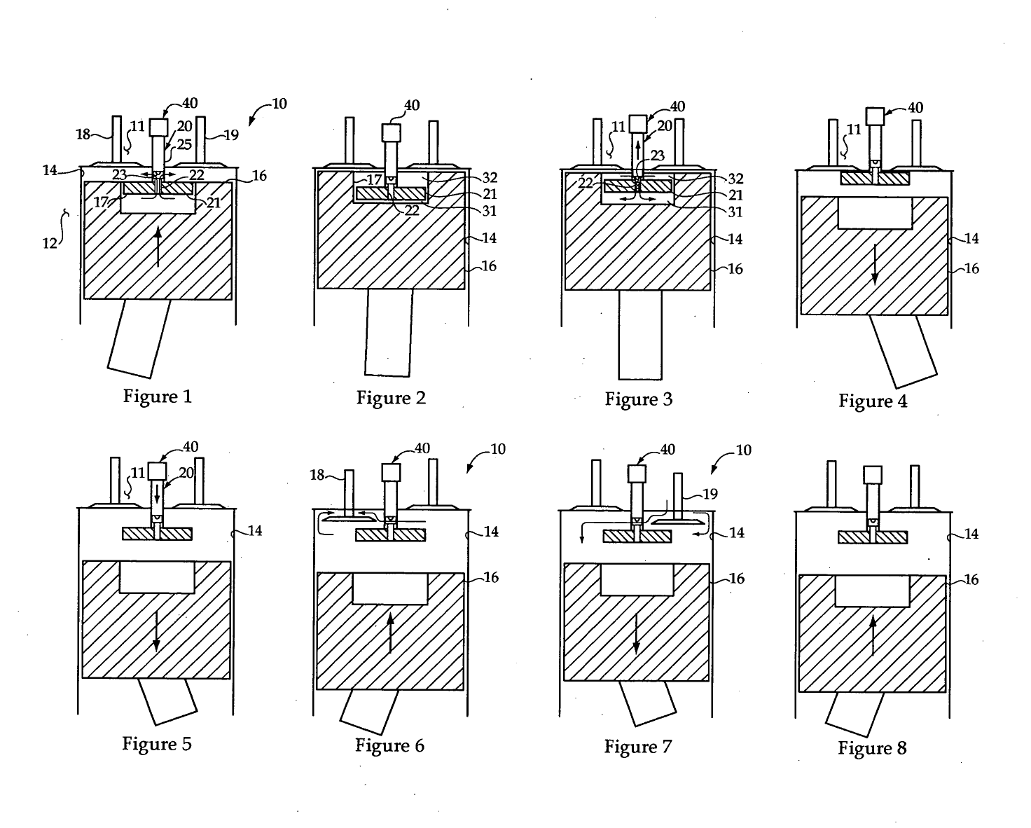

Referring now to FIGS. 1-8, an example sequence of events for one engine cycle according to the present disclosure is illustrated. FIG. 1 shows engine 10 during a compression stroke. Like many engines, engine 10 includes an engine housing made up of a head 11 and a block 12. The housing 11, 12 defines an engine cylinder or combustion chamber 14 within which a piston 16 reciprocates in a conventional manner. Also like many engines, engine 10 includes at least one exhaust valve 18 and at least one intake valve 19 to facilitate the evacuation of exhaust gases and intake of fresh air, respectively, into engine cylinder 14. Also like many direct injection engines, engine 10 includes a fuel injector 20 with a nozzle 23 positioned to inject fuel directly into engine cylinder 14. However, unlike previous engines, engine 10 includes an air displacement actuator 40 that includes fuel injector 20 and a separator member 21 that move together with respect to both the engine housing 11, 12 and the engine piston 16 when air displacement actuator 40 is actuated.

In FIG. 1, air displacement actuator 40 is shown in its lower most position such that separator member 21 is at its farthest location from engine head 11. As the compression stroke continues, piston 16 rises in engine cylinder 14 toward a top dead center position. During this movement, separator member 21 is received in an opening 17 in piston 16. The nozzle of fuel injector 20 is not only positioned within engine cylinder 14, but is also positioned to inject fuel into a flow passage 22 that is defined by injector body 25 and separator member 21 of air displacement actuator 40. The outer diameter/inner diameter clearance between separator member 21 and opening 17 can be set to any suitable magnitude that avoids collision while promoting the bulk of air movement in cylinder 14 through flow passage 22 rather than around the outer diameter of separator member 21. Thus, as the compression stroke continues, the air in opening 17 of piston 16 is forced upward through flow passage 22 as piston 16 approaches top dead center.

Referring now to FIG. 2, the engine 10 is shown when piston 16 is in the vicinity of top dead center. After separator member 21 is received in opening 17 of engine piston 16, the separator member 21 divides the air in cylinder 14 between a first volume 31 and a second volume 32. The first volume 31 and the second volume 32 are fluidly connected via flow passage 22. At the point shown in FIG. 2, the air in cylinder 14 has been compressed to a point beyond an autoignition condition of fuel to be injected into cylinder 14, in a manner similar to that of a conventional diesel engine. However, it is believed that engines in accordance with the present disclosure may permit a lower compression ratio, such as on the order of maybe 16 to 1, which may be lower than that of conventional diesel engines.

Referring to FIG. 3, when the engine piston 16 is lingering in the vicinity of top dead center the air displacement actuator 40 is actuated. As used in the disclosure, the term “vicinity of top dead center” means an engine angle after which autoignition conditions have arisen in engine cylinder 14 so that injected fuel will autoignite after an ignition delay upon injection into the compressed air. For simplicity, FIG. 3 shows air displacement actuator 40 being actuated at top dead center, but this event could occur before or after top dead center, although the most air movement past nozzle 23 through flow passage 22 would hypothetically be facilitated by quick movement of separator member 21 at top dead center. However, the present disclosure recognizes that real events in real engines require a finite amount of time. For instance, the movement duration of air displacement actuator 40 will inherently occupy some angle of engine rotation while in the vicinity of top dead center. Likewise, an injection duration will not occur instantaneously and will occur over an engine angle of rotation. The best results are believed to be achieved when the fuel injection event starts after the air displacement actuator 40 is initially actuated, but ends before the air displacement actuator 40 has completed its movement. Nevertheless, the present disclosure recognizes that because real events take time to occur, this ideal may not always be achievable. Thus, those skilled in the art will appreciate that there may be overlap between the injection event duration timing and the air displacement actuator event timing, but that scenario still falls within the contemplated scope of the present disclosure.

In the illustrated embodiment, when the air displacement actuator 40 is actuated, separator member 21 and fuel injector 20 are driven upwards toward engine head 11. This causes a quick displacement of the compressed air from second volume 32 to first volume 31 through flow passage 22. While this air movement is occurring, fuel is injected from nozzle 23 into the turbulent compressed air moving through flow passage 22. By injecting during the air movement, each atomized droplet of fuel may encounter its own pocket of fresh compressed air. After some ignition delay, the mixture of fuel and air will auto-ignite within first volume 31, thus concentrating the combustion heat in piston 16, rather than in or adjacent to the engine head 14 or the cylinder walls that define cylinder 14.

Referring now to FIG. 4, the expansion stroke is shown in progress and the air displacement actuator 40 is shown in its upper most position closest to engine head 11. As in a typical engine, the expansion stroke progresses due to the high combustion gas pressure pushing on piston 16 to urge its travel downward in a conventional manner. Referring to FIG. 5, toward the end of the expansion stroke, the air displacement actuator 40 is returned to its initial position for a subsequent combustion event. This may be accomplished in any suitable manner, such as a biaser strategy, which may include a biasing spring that normally urges air displacement actuator 40 toward its downward most position away from head 11, as shown.

FIG. 6 shows engine 10 during the exhaust stroke. When this occurs, exhaust valve 18 moves into cylinder 14 in a conventional manner to facilitate the evacuation of combustion gases to an exhaust passage (not shown). Since the air displacement actuator 40 had reset to its downward position prior to the exhaust stroke, the risk of potential problems associated with collision between exhaust valve 18 and air displacement actuator 40 are avoided. Furthermore, potential collisions can be further ensured against by exploiting known strategies for cams and gearing typically utilized to avoid the possibility of potential collisions between exhaust or intake valves and the engine piston 16. FIG. 7 shows engine 10 during the intake stroke where intake valve 19 is moved to allow fresh air to enter engine cylinder 14 in a conventional manner. Finally, FIG. 8 shows the beginning of a subsequent compression stroke. Thus, FIGS. 1-8 show a typical four cycle engine operation, but with the addition of the action provided by actuation of air displacement actuator 40 in the vicinity of top dead center between the compression and expansion strokes.

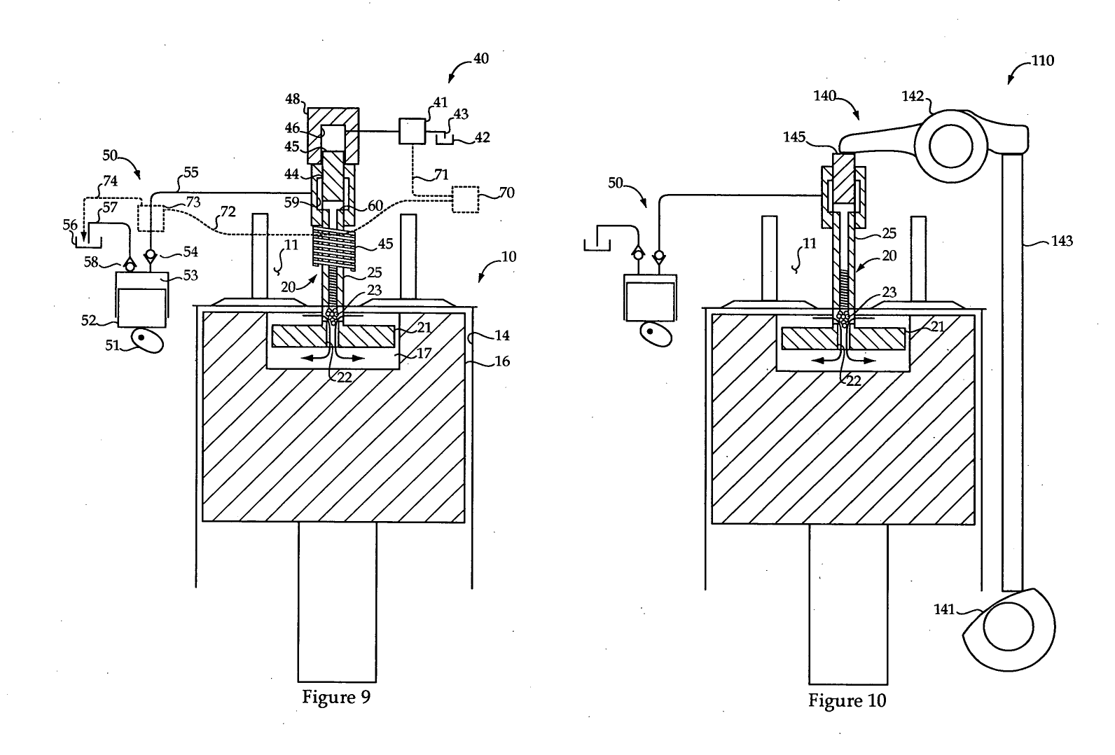

Referring now to FIG. 9, one example fuel system 50 is shown in greater detail. In addition, one embodiment of an air displacement actuator 40 that utilizes hydraulic control is also included. FIG. 9 shows engine 10 during an air displacement actuation event that is simultaneous with a fuel injection event when engine piston 16 is in the vicinity of top dead center. It is believed that because the engine 10 of the present disclosure brings air to the fuel via the air flow in the vicinity of the fuel injector nozzle 23, lower injection pressures and possibly a more simpler fuel system 50 may be utilized. For instance, fuel system 50 is illustrated as a conventional pump-in-line fuel system that includes a rotating cam 51 that moves a unit pump piston 52 to pressurize fuel in a pumping chamber 53. The fuel is pumped past a check valve 54 along a fuel supply line 55 to a fuel volume 59 within a fixed housing 48 of air displacement actuator 40. Fuel volume 59 opens into injector body 25 of fuel injector 20 via an inlet passage 60. Fuel injector 20 works in the illustrated embodiment as a simple spring biased check that opens when fuel pressure in fuel volume 59, and hence within injector body 25, exceeds a valve opening pressure (defined by a preload on an internal biasing spring) in a conventional manner. In the pump-in-line fuel system 50 illustrated below, the cam 51 is timed to cause a fuel injection event in the vicinity of top dead center for piston 16 in a conventional manner. Fuel system 50 also includes a fuel tank 56 that supplies low pressure fuel to pumping chamber 53 via a pump supply line 57 past a check valve 58.

Those skilled in the art will appreciate that any fuel system 50 could be compatible with the present disclosure. However, the advantages of the present invention may allow for a fuel system that achieves low emissions without reliance upon sophisticated electronic control via one or more electrical actuators. But the present disclosure does contemplate electronic control. For instance, an electronic control module 70 may communicate with an electronically controlled spill valve 73 via a communication line 72. When pump piston 52 initially displaces fuel in pump chamber 53, the fuel may be displaced back to fuel tank 56 via a return line 74 until that passageway is closed via an electronic control module 70 in a conventional manner. Such an alternative strategy would permit injection timing control somewhat independent of engine crank angle. Thus, the present disclosure does contemplate electronic control, but need not necessarily require the same. The present disclosure also contemplates other types of fuel systems, including but not limited to common rail fuel systems with an electronically controlled admission valve and/or electronic needle control valve. The present disclosure also contemplates other fuel systems, but prefers to avoid inclusion of an electronic actuator in injector body 25 since fuel injector 20 moves with actuation of air displacement actuator 40. Nevertheless, a moving fuel injector with one or more electrical actuators does fall within the contemplated scope of this disclosure.

In the embodiment of FIG. 9, fuel injector 25 includes an actuation surface 45 that is exposed to fluid pressure in an actuator volume 46 within fixed housing 48. Thus, the up and down forces on fuel injector 20 include cylinder pressure pushing upwards toward cylinder head 11 and a combination of a hydraulic force on actuation surface 45 plus the return biaser force provided by a biasing spring 45 that urges fuel injector 20 downward away from head 11. An air displacement actuation event is initiated by opening a control valve 41 that fluidly connects actuation volume 46 to low pressure hydraulic fluid reservoir 42 via a hydraulic passage 43. The high pressure in cylinder 14 then urges fuel injector 20 upward against the action of biasing spring 45 to evacuate fluid from actuation volume 46. Although the opening of control valve 41 may be mechanical without electronic control, the present disclosure also contemplates an electronically controlled valve 41 that is opened and closed via control signals from electronic control module 70 delivered via communication lines 71. This disclosure also contemplates activation via high pressure hydraulic fluid that moves the member 21 in a desirable direction to facilitate air movement.

Referring now to FIG. 10, an engine 110 is identical to the engine 10 of FIG. 9 except that the air displacement actuator 140 is cam controlled rather than hydraulically controlled as in the previous embodiment. In particular, air displacement actuator 140 includes a rotating cam 141 that is coupled to rotate once per two revolutions of the engine's crank shaft. The cam surface 141 acts on rocker arm 142 via a lifter 43. In turn, rocker arm 142 acts on an actuation surface 145 of fuel injector 20. Although not shown, this embodiment may also include some biasing means to maintain actuation surface 145 as following the contour of cam 141. When it comes time for the air displacement actuator 140 to actuate, the cam surface allows cylinder pressure to push upward on fuel injector 20 to move the same toward head 11, in a manner similar to the previous embodiment where the valve 41 was opened to facilitate actuation of its air displacement actuator. This embodiment has a fixed timing actuation of the air displacement actuator. Using an appropriate gearing of the camming strategies, any potential collisions between fuel injector 20 and the respective intake and exhaust valves can be avoided. This disclosure also contemplates different movements facilitated by cam rotation by itself or combined with hydraulic forces to produce desired motion. For instance, cam movement coupled with hydraulic control could allow for variable timing of air displacement activation events.

### INDUSTRIAL APPLICABILITY

The strategy of the present disclosure is applicable to any compression ignition internal combustion engine. The disclosure finds specific application in cases where it is desired to reduce the production of undesirable emissions including NOx, unburned hydrocarbons and particulate matter at the point of combustion rather than via aftertreatment. In fact, it is possible that an engine equipped and operated according to the present disclosure may allow for the elimination of some or all aftertreatment devices. In addition, an engine of the present disclosure can likely operate at a lower compression ratio than conventional diesel engines. This lower compression ratio should reduce mechanical stresses on the engine allowing for lighter engines and their associated performance cost savings. By bringing turbulent air to the fuel at the fuel injector nozzle, improved atomization and mixing of the fuel with air for leaner combustion is possible without the need for ever more elevated injection pressures as in conventional engine systems. In addition, besides the ability to perform with lower injection pressures, the fuel injector does not need to perform the same high levels of atomization as those necessary for conventional diesel engine fuel injection systems. Maybe more importantly, the problems associated with over penetration of small droplets as in today's diesel engines is of far less concern. It should be noted that the motion of the separator member 21 increases the volume in the cylinder at top dead center and transmits the work back into the cam shaft and finally into the crank shaft, in the case of the embodiment of FIG. 10. The combustion of fuel later in the cycle, as in current diesel engines, increases the pressure and temperature in the combustion chamber which increases the temperature of the already combusted gases, further increasing NOx production. The approach of the present disclosure more closely resembles a constant pressure combustion system compared to the current combination of Otto cycle and constant pressure combustion. Unlike Rudolph Diesel's designs of constant pressure combustion, the constant pressure combustion is not created by combusting fuel late in the cycle where the effective expansion ratio is reduced. In the approach of the present disclosure, the efficiency of the Otto cycle is married with the high efficiency of the compression ignition effective expansion ratio while providing low emissions from lower peak combustion temperatures. In addition, by promoting combustion in the opening 17 in the engine piston 16, losses due to heat rejection through the cylinder walls and engine head may be reduced relative to other alternative combustion strategies.

Referring again to FIGS. 9 and 10, when the engine piston 16 is in the vicinity of top dead center, the air displacement actuator 40, 140 is actuated to move separator member 21 upward toward the engine head. This causes air in cylinder 14 to be displaced through flow passage 22. This highly compressed air flow passes adjacent the fuel injector nozzle 23. Fuel is injected directly into the turbulent air flow. After a brief ignition delay, the fuel ignites and substantially burns in the volume defined by the opening 17 in piston 16.

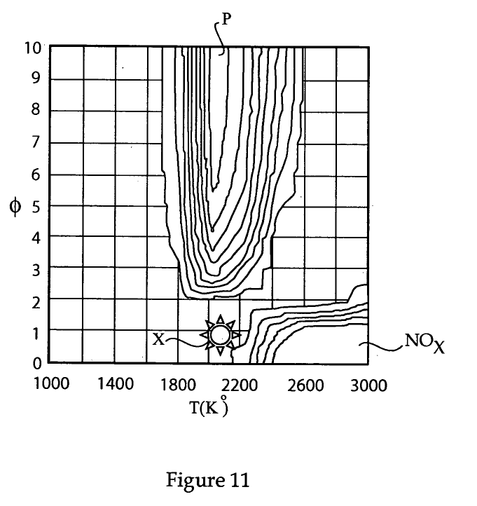

By injecting into the highly compressed moving air, the advantages with regard to ignition timing associated with conventional diesel engines can be married to the relatively low emissions associated with combustion strategies akin to homogenous charge compression ignition, but without the problems associated with ignition timing. In addition, many of the ever increasing demands on fuel systems relating to electrical actuators, electronic control, elevated fuel pressures, better atomization, better penetration and the like are believed to be relaxed using the strategies described above. By appropriately adjusting and tuning the system, it is believed that combustion can be driven to occur in the Region X as shown in FIG. 11 that is between the NOx production regimes and the particulate matter production regimes to produce relatively cleaner exhaust with less need of after treatment.

Although the present disclosure has been illustrated in the context of a fuel injector that includes a separator member that moves in response to actuation of the air displacement actuator, the present disclosure is not so limited. For instance, the fuel injector need not necessarily be part of the air displacement actuator and may in an alternative design be a component fixed in the engine head. The important aspect of the present disclosure is moving the highly compressed air in the vicinity of top dead center adjacent the fuel injector nozzle so that each droplet of fuel encounters fresh air to facilitate clean lean combustion at lower temperatures.

It should be understood that the above description is intended for illustrative purposes only, and is not intended to limit the scope of the present invention in any way. Thus, those skilled in the art will appreciate that other aspects of the invention can be obtained from a study of the drawings, the disclosure and the appended claims.

1. A method of operating an internal combustion engine, comprising the steps of:
compressing air in an engine cylinder by moving an engine piston toward a top dead center position;
displacing the air through a flow passage within the engine cylinder when the engine piston is in a vicinity of top dead center by moving an air displacement actuator with respect to the engine cylinder and the engine piston;
injecting fuel into the flow passage;
compression igniting a mixture of the air and the fuel in the engine cylinder; and
returning the air displacement actuator to an initial position for a subsequent combustion event after the compression igniting step.

2. The method of claim 1 including a step of moving a fuel injector nozzle relative to the engine piston and the engine cylinder during the injecting step.

3. The method of claim 2 wherein the air displacement actuator includes a cam coupled to rotate responsive to rotation of a crank shaft coupled to the engine piston;
the step of moving the air displacement actuator includes rotating the cam.

4. The method of claim 2 wherein the air displacement actuator includes a hydraulically driven piston exposed to fluid pressure in an actuator volume; and
the step of moving the air displacement actuator includes fluidly connecting the actuator volume to a hydraulic fluid passage.

5. The method of claim 1 including a step of dividing the air between a first volume and a second volume with a separator when the engine piston is in the vicinity of top dead center; and
fluidly connecting the first volume to the second volume via the flow passage.

6. The method of claim 5 wherein the displacing step includes moving the separator with the air displacement actuator.

7. The method of claim 6 wherein the air displacement actuator includes a cam coupled to rotate responsive to rotation of a crank shaft coupled to the engine piston; and
the step of moving the air displacement actuator includes rotating the cam.

8. The method of claim 6 wherein the air displacement actuator includes a hydraulically driven piston exposed to fluid pressure in an actuator volume; and
the step of moving the air displacement actuator includes fluidly connecting the actuator volume to a hydraulic fluid passage.

9. The method of claim 6 wherein the step of moving the separator includes receiving the separator into an opening defined by the engine piston during a portion of the displacing step.

10. The method of claim 6 including a step of biasing the separator toward the engine piston.

11. The method of claim 1 wherein the fuel is a liquid at a point of injection.

12. (canceled)

13. The engine of claim 18 wherein the member is received in an opening in the piston at top dead center.

14. The engine of claim 18 wherein the fuel injector is operably coupled to the air displacement actuator to move with the member.

15. The engine of claim 18 wherein the air displacement actuator includes a rotating cam.

16. The engine of claim 18 wherein the air displacement actuator includes a piston exposed to fluid pressure in an actuator volume.

17. The engine of claim 18 including a biaser operably positioned to bias the member in a direction toward the piston.

18. An engine comprising:
a housing defining at least one combustion chamber;
a piston positioned to reciprocate in each of the at least one combustion chamber;
an air displacement actuator with a member positioned in the combustion chamber, and the member moving with respect to the housing and the piston when the air displacement actuator is actuated, but being biased to return to an initial position after being actuated;
a fuel injector with a nozzle positioned in the combustion chamber;
the member defines a flow passage therethrough; and
the fuel injector is positioned to inject fuel into the flow passage.

19. The engine of claim 18 wherein the member is received in an opening in the piston at top dead center.

20. An air displacement actuator comprising:
a fuel injector with an injector body that includes an actuation surface and a member that defines a flow passage therethrough; and
at least one nozzle opening that opens within the flow passage.
